(19) United States
(12) Patent Application Publication
(10) Pub. No.: US 2023/0244948 A1
(43) Pub. Date: Aug. 3, 2023

(54) DETERMINATION CONTROL DEVICE AND METHOD

(71) Applicant: FUJITSU LIMITED, Kawasaki-shi (JP)

(72) Inventors: Keizo KATO, Kawasaki (JP); Akira NAKAGAWA, Sagamihara (JP)

(73) Assignee: FUJITSU LIMITED, Kawasaki-shi (JP)

(21) Appl. No.: 18/119,333

(22) Filed: Mar. 9, 2023

Related U.S. Application Data
(63) Continuation of application No. PCT/JP2020/035558, filed on Sep. 18, 2020.

(51) Int. Cl. G06N 3/088; G06F 21/60; G06N 7/01

(52) U.S. Cl. CPC G06N 3/088; G06F 21/602; G06N 7/01

(57) ABSTRACT

A determination control device includes a processor that executes a procedure. The procedure includes estimating, as a probability distribution, a low-dimensional feature value obtained by encrypting input data, the low-dimensional feature value having a lower dimensionality than the input data, generating output data by decrypting a feature value resulting from adding noise to the low-dimensional feature value, and adjusting respective parameters of the encrypting, the estimating, and the decrypting, based on a cost including an error between the input data and the output data and including an entropy of the probability distribution, wherein, in a determination as to whether or not target input data is normal, a determination standard for the determination is controlled based on information obtained from another probability distribution estimated by encrypting the target input data with the parameters after adjusting.

### CROSS-REFERENCE TO RELATED APPLICATION

This application is a continuation application of International Application No. PCT/JP2020/035558, filed Sep. 18, 2020, the disclosure of which is incorporated herein by reference in its entirely.

### FIELD

The embodiments discussed herein are related to a non-transitory recording medium storing a determination control program, determination control device, and determination control method.

### BACKGROUND

Hitherto a probability distribution of normal data is learnt by unsupervised training, and abnormal data is detected by comparing a probability distribution of determination target data against the normal data probability distribution.

For example, technology is proposed in which a probability distribution of latent space proportional to a probability distribution in real space is captured by an autoencoder compatible with rate-distortion theory that minimizes latent variable entropy, and abnormal data is detected from a difference to the latent space probability distribution. For example, related arts are disclosed in Rate-Distortion Optimization Guided Autoencoder for Isometric Embedding in Euclidean Latent Space (ICML2020) and “Fujitsu Develops World's First AI technology to Accurately Capture Characteristics of High-Dimensional Data Without Labeled Training Data”, [online] , Jul. 13, 2020 [search date Sep. 13, 2020], Internet<URL: https://www.fujitsu.com/global/about/resources/news/press-releases/2020/0713-01.html>

### SUMMARY

According to an aspect of the embodiments, a non-transitory recording medium is stored with a determination control program that causes a computer to execute a process. The process includes estimating, as a probability distribution, a low-dimensional feature value obtained by encrypting input data, the low-dimensional feature value having a lower dimensionality than the input data, generating output data by decrypting a feature value resulting from adding noise to the low-dimensional feature value, and adjusting respective parameters of the encrypting, the estimating, and the decrypting based on a cost including an error between the input data and the output data and including an entropy of the probability distribution, wherein, in a determination as to whether or not target input data is normal, a determination standard for the determination is controlled based on information obtained from another probability distribution estimated by encrypting the target input data with the parameters after adjusting are employed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram to explain issues in cases in which abnormality determination is performed using a probability distribution of low-dimensional feature values.

FIG. 2 is a functional block diagram of a determination control device.

FIG. 3 is a diagram for explaining functions during training in a first exemplary embodiment.

FIG. 4 is a diagram for explaining functions during determination in the first exemplary embodiment.

FIG. 5 is a block diagram illustrating a schematic configuration of a computer that functions as a determination control device.

FIG. 6 is a flowchart illustrating an example of training processing in the first exemplary embodiment.

FIG. 7 is a flowchart illustrating an example of determination processing in a first exemplary embodiment.

FIG. 8 is a diagram for explaining of a function during training in a second exemplary embodiment.

FIG. 9 is a diagram for explaining a peripheral region to a pixel of interest.

FIG. 10 is a diagram for explaining a peripheral region to a pixel of interest.

FIG. 11 is a diagram for explaining a function during determination in the second exemplary embodiment.

FIG. 12 is a flowchart illustrating an example of training processing in the second exemplary embodiment.

FIG. 13 is a flowchart illustrating an example of determination processing in the second exemplary embodiment.

### DESCRIPTION OF EMBODIMENTS

Explanation follows regarding an example of an exemplary embodiment according to technology disclosed herein, with reference to the drawings.

First, prior to explaining details about each exemplary embodiment, explanation follows regarding issues in cases in which normal/abnormal determination uses a probability distribution exhibited by a low-dimensional feature extracted from input data, and in cases in which features in input data exhibit various probability distributions.

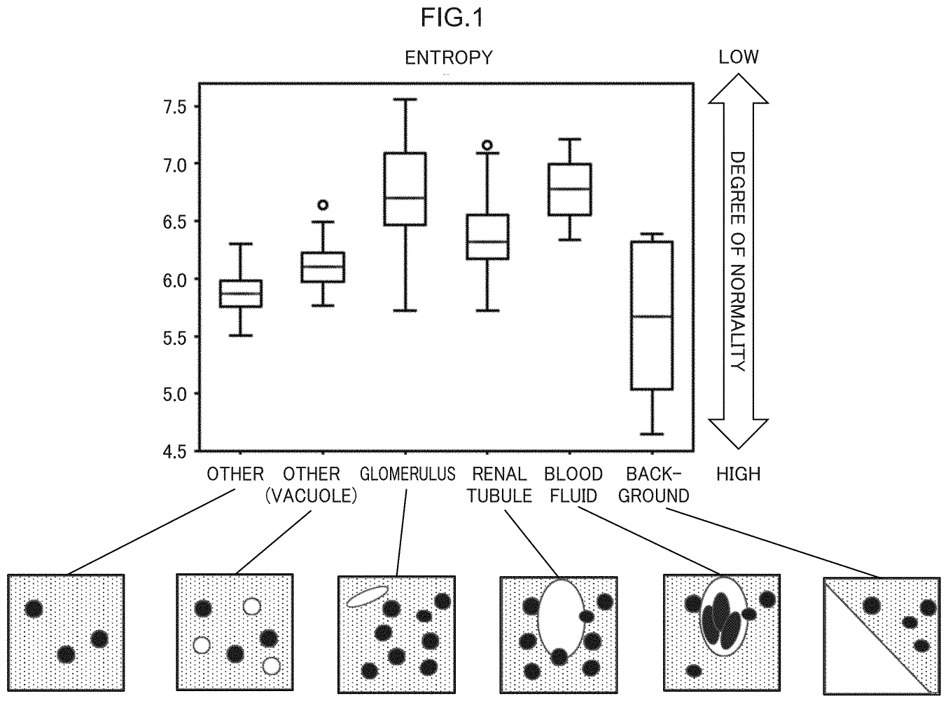

Explanation follows regarding an example of a case in which in which medical images imaging an organ of a human body or the like serve as the input data. Examples of medical images serving as the input data are schematically illustrated at a lower part of FIG. 1. In the example of FIG. 1, a state in which a vacuole has not developed is determined as being normal, and a state in which a vacuole has developed is determined as being abnormal. In such cases, as illustrated by the “other” medical image in FIG. 1, entropy of a low-dimensional feature extracted from a target medical image in which no vacuole has developed is extracted as a standard, and normal or abnormal is determined by evaluating the entropy of the low-dimensional feature extracted from a target medical image against this standard. More specifically, as illustrated at an upper part of FIG. 1, the “other (vacuole)” medical image can be determined as being abnormal from a difference between the entropy of the “other” indicating normal and the entropy of the “other (vacuole)”.

However, as illustrated at the lower part of FIG. 1, sometimes such medical images contain formations such as a glomerulus, renal tubule, blood fluid, or the like, or a background, creating highs and lows in the entropy due to the formations and background respectively contained therein. Thus sometimes determination as normal or abnormal is not able to be made with good accuracy in cases in which the entropy of “other” indicating normal is taken as the standard, and the entropy of abnormal data is buried in the differences in entropy for each of the formations as described above.

Thus in order to address this, control is performed in each of the following exemplary embodiments so as to enable determination of normal or abnormal with good accuracy even in cases in which a probability distribution exhibited by a low-dimensional feature extracted from the input data exhibits various probability distributions.

### First Exemplary Embodiment

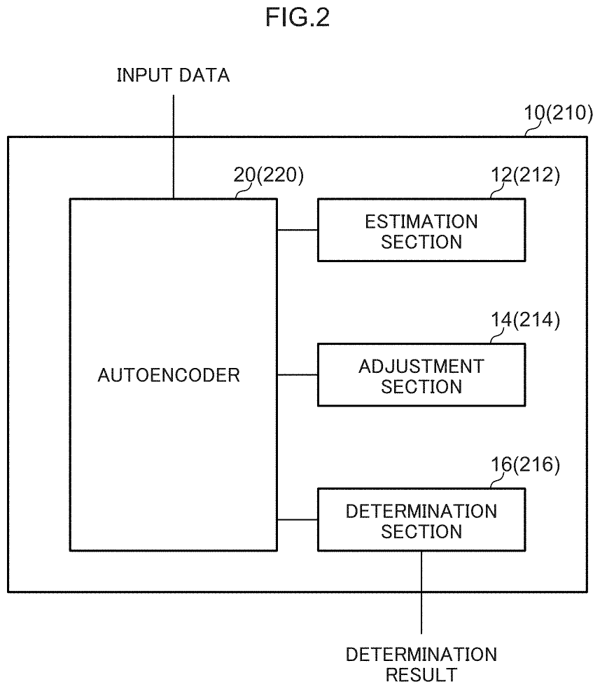

A determination control device 10 according to a first exemplary embodiment includes, from a functional perspective, an autoencoder 20, an estimation section 12, an adjustment section 14, and a determination section 16, as illustrated in FIG. 2. The estimation section 12 and the adjustment section 14 function during training of the autoencoder 20, and the estimation section 12 and the determination section 16 function during normal/abnormal determination using the autoencoder 20. Explanation follows regarding a detailed configuration of the autoencoder 20 and regarding the function of each functional section during training and during determination, respectively.

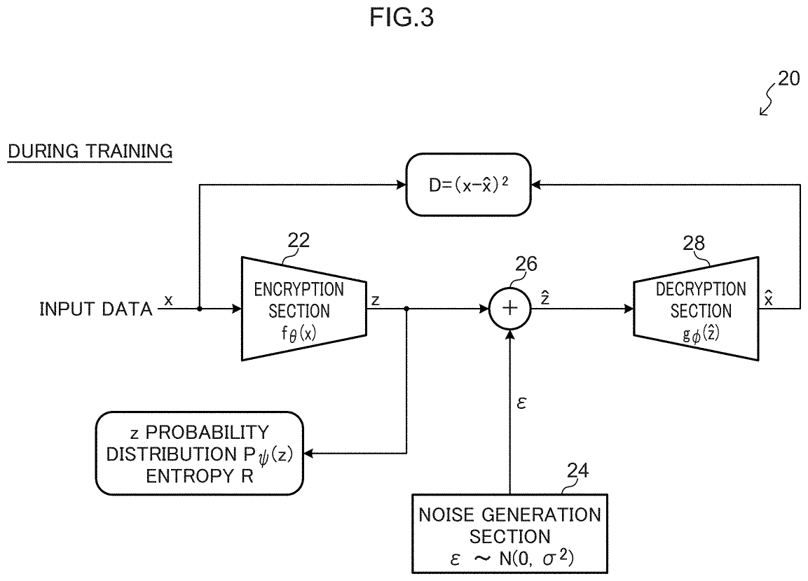

First, explanation follows regarding functional sections that function during training, with reference to FIG. 3.

The autoencoder 20 includes an encryption section 22, a noise generation section 24, an adding section 26, and a decryption section 28, as illustrated in FIG. 3.

The encryption section 22 encrypts multi-dimensionality input data so as to extract a low-dimensional feature value z having a lower dimensionality than the input data. More specifically, the encryption section 22 extracts the low-dimensional feature value z from input data x using an encryption function f_{θ}(x) including a parameter θ. For example, the encryption section 22 is able to apply a convolutional neural network (CNN) algorithm as the encryption function f_{θ}(x). The encryption section 22 outputs the extracted low-dimensional feature value z to the adding section 26.

The noise generation section 24 generates noise ε that is a random number based on a distribution having the same dimensionality as the low-dimensional feature value z, having no inter-correlation between dimensions, and having a mean of 0. The noise generation section 24 outputs the generated noise ε to the adding section 26.

The adding section 26 generates a low-dimensional feature value z\hat{ } (denoted by “\hat{ } (hat)” above “z” in the drawings) resulting from adding the noise ε input from the noise generation section 24 to the low-dimensional feature value z input from the encryption section 22, and outputs the low-dimensional feature value z\hat{ } to the decryption section 28.

The decryption section 28 generates output data x\hat{ } (denoted by “\hat{ } (hat)” above “x” in the drawings) having the same dimensionality as input data x by decrypting the low-dimensional feature value z\hat{ } input from the adding section 26. More specifically, the decryption section 28 generates the output data x\hat{ } from the low-dimensional feature value z\hat{ } by using a decryption function g_{φ}(z\hat{ }) including a parameter φ. For example, the decryption section 28 may apply a transposed CNN algorithm as the decryption function g_{φ}(z\hat{ }).

The estimation section 12 acquires the low-dimensional feature value z extracted by the encryption section 22, and estimates the low-dimensional feature value z as a probability distribution. More specifically, the estimation section 12 estimates a probability distribution P_{ψ}(z) including parameter ψ using a probability distribution mixture model configured from plural distributions. The present exemplary embodiment will now be described for a case in which the probability distribution model is a Gaussian mixture model (GMM). In this case the estimation section 12 estimates a probability distribution P_{ψ}(z) by calculating parameters π, Σ, μ of the following Equation (1) using a maximum likelihood estimation method or the like.

$${P}_{ψ} ( z ) = {\sum }_{k = 1}^{K} {π}_{k} \frac{exp ( - \frac{1}{2} {( z - {μ}_{k} )}^{T} {Σ}_{k}^{- 1} ( z - {μ}_{k} ) )}{\sqrt{\vert 2 π {\sum }_{k} \vert}} \qquad ( 1 )$$

In Equation (1) K is a number of the normal distributions contained in the GMM, μₖ is a mean vector of the k^{th} normal distribution, Σₖ is a covariance matrix of the k^{th} normal distribution, and πₖ is a weight (mixing coefficient) of the k^{th} normal distribution, wherein the sum of all πₖ=1. Moreover, the estimation section 12 computes an entropy R of the probability distribution P_{ψ}(z)=−log (P_{ψ}(z)).

The adjustment section 14 adjusts each of the respective parameters θ, φ, ψ of the encryption section 22, the decryption section 28, and the estimation section 12 based on a training cost including an error between input data x and output data x\hat{ } corresponding to this input data and including the entropy R computed by the estimation section 12. For example, as expressed by the following Equation (2), the adjustment section 14 repeatedly performs processing to generate the output data x\hat{ } from the input data x while updating the parameters θ, φ, ψ so as to minimize a training cost L₁ expressed by a weighted sum of the error between x and x\hat{ }, and the entropy R. The parameters of the autoencoder 20 and the estimation section 12 are trained thereby.

L₁=E_{x˜p(x),ε˜N(0,σ}_{²}₎[R+λ·D] (2)

Note that in Equation (2) λ is a weighting coefficient and D is an error between x and x\hat{ }, for example D=(x−x\hat{ })².

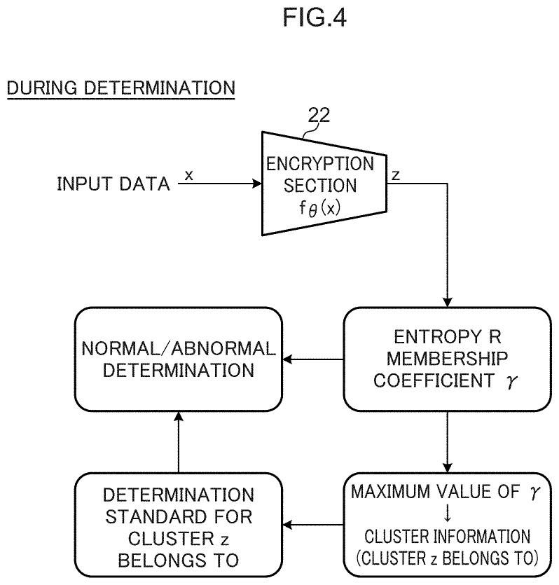

Next, description follows regarding functional sections that function during determination, with reference to FIG. 4. Note that input data during determination is an example of “determination target input data” of technology disclosed herein.

The encryption section 22 extracts the low-dimensional feature value z from the input data x by encrypting the input data x based on an encryption function f_{θ}(x) set with the parameter θ after being adjusted by the adjustment section 14.

The estimation section 12 acquires the low-dimensional feature value z extracted by the encryption section 22, and estimates the probability distribution P_{ψ}(z) of the low-dimensional feature value z by using the GMM set with the parameter ψ after being adjusted by the adjustment section 14. Moreover, the estimation section 12 computes the entropy R of the probability distribution P_{ψ}(z)=−log (P_{ψ}(z)) similarly to during training. Furthermore, the estimation section 12 also computes a membership coefficient γ indicating a probability that the low-dimensional feature value z belongs to each of the plural normal distributions configuring the GMM. In cases in which the GMM is configured from K normal distributions, f_{π}(πₖ)=γₖ that can be computed from the weights πₖ of the normal distributions included in Equation (1) is employed to express the membership coefficient γ as a K dimensional vector γ=(γ₁, γ₂, . . . , γₖ, . . . , γ_{K}). The membership coefficient γ is accordingly computed in the process of estimating the probability distribution P_{ψ}(z).

The determination section 16 uses the adjusted parameters θ, φ, ψ to control a determination standard to determine whether or not the determination target input data is normal by controlling based on information obtained from the probability distribution P_{ψ}(z). More specifically, the determination section 16 employs the membership coefficient γ computed by the estimation section 12 as information obtained from the probability distribution P_{Ω}(z), and identifies cluster information indicating which cluster the low-dimensional feature value z belongs to from among plural clusters equivalent to the plural normal distributions configuring the GMM.

By training a probability distribution model configured from plural distributions, such as a GMM, as the probability distribution model, the parameter ψ of the GMM is adjusted such the plural normal distributions corresponding to a trend in a broad feature exhibited by the low-dimensional feature value z are contained in the probability distribution model. For example, in cases in which the input data is medical images such as illustrated in FIG. 1, the parameter ψ of the GMM is adjusted such that normal distributions corresponding to each respective type, such as formation or the like, are contained. Thus each of the plural normal distributions configuring the GMM are equivalent to respective clusters for classifying input data type (types such as formation or the like in the example of FIG. 1). The determination section 16 identifies the cluster that the low-dimensional feature value z belongs as being the cluster equivalent to the normal distribution corresponding to the maximum coefficient from among the coefficients γₖ (k=1, 2, . . . , K) contained in the K dimensional vector that is the membership coefficient γ.

Then from among determination standards pre-determined for each respective cluster, determination section 16 sets the determination standard corresponding to the identified cluster information, namely corresponding to the cluster the low-dimensional feature value z belongs to. Note that the determination standard for each respective cluster can be determined in advance experimentally. For example, the entropy computed during training for each respective cluster the low-dimensional feature value z belongs to may be employed as the determination standard for each respective cluster.

For the determination target input data, the determination section 16 determines whether the input data is normal or abnormal by comparing the entropy computed by the estimation section 12 against the determination standard set according to the cluster information, and outputs a result of the determination.

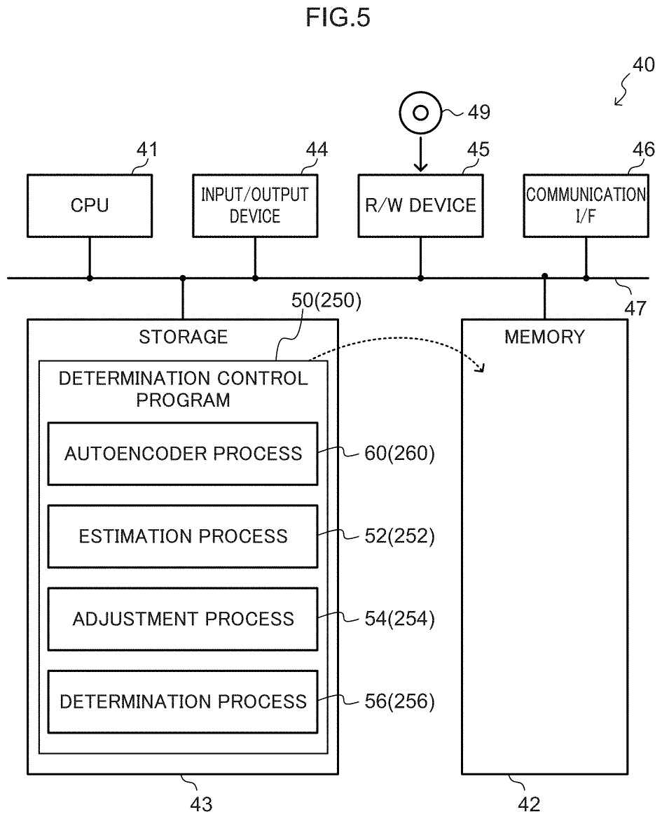

The determination control device 10 may, for example, be implemented by a computer 40 as illustrated in FIG. 5. The computer 40 is equipped with a central processing unit (CPU) 41, memory 42 serving as temporary storage space, and a non-transitory storage section 43. The computer 40 also includes an input/output device 44 such an input section, display section, and the like, and a read/write (R/W) section 45 to control reading data from a storage medium 49 and writing data thereto. The computer 40 also includes a communication interface (I/F) 46 connected to a network such as the Internet. The CPU 41, the memory 42, the storage section 43, the input/output device 44, the R/W section 45, and the communication I/F 46 are mutually connected together through a bus 47.

The storage section 43 may be implemented by, for example, a hard disk drive (HDD), solid state drive (SSD), or flash memory. A determination control program 50 to cause the computer 40 to function as the determination control device 10 by executing training processing and determination processing, described later, is stored on the storage section 43 serving as a storage medium. The determination control program 50 includes an autoencoder process 60, an estimation process 52, an adjustment process 54, and a determination process 56.

The CPU 41 reads the determination control program 50 from the storage section 43, expands the determination control program 50 into the memory 42, and sequentially executes the processes of the determination control program 50. The CPU 41 operates as the autoencoder 20 illustrated in FIG. 2 by executing the autoencoder process 60. The CPU 41 operates as the estimation section 12 illustrated in FIG. 2 by executing the estimation process 52. The CPU 41 operates as the adjustment section 14 illustrated in FIG. 2 by executing the adjustment process 54. The CPU 41 operates as the determination section 16 illustrated in FIG. 2 by executing the determination process 56. The computer 40 that has executed the determination control program 50 accordingly functions as the determination control device 10. Note that the CPU 41 executing the program is hardware.

The functions implemented by the determination control program 50 may be implemented by, for example, a semiconductor integrated circuit, and more particularly by an application specific integrated circuit (ASIC).

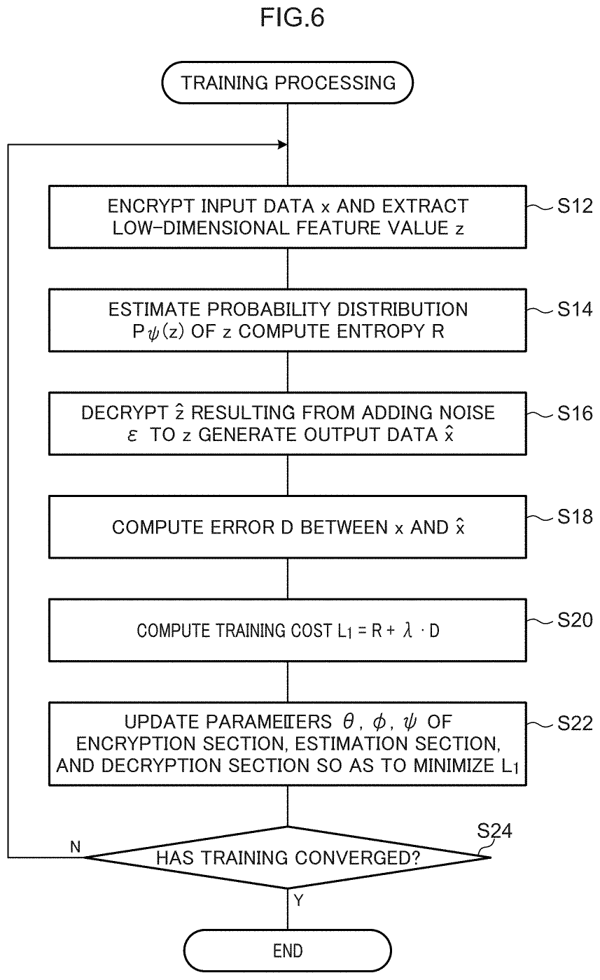

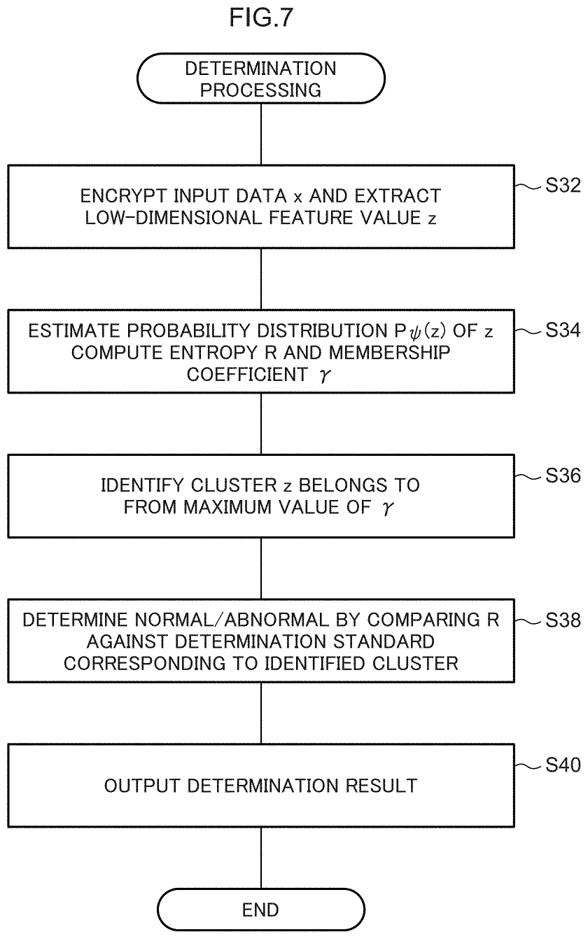

Next, description follows regarding operation of the determination control device 10 according to the first exemplary embodiment. When adjusting the parameters of the autoencoder 20 and the estimation section 12, training input data x is input to the determination control device 10, and the training processing illustrated in FIG. 6 is executed in the determination control device 10. Moreover, the determination processing illustrated in FIG. 7 is executed in the determination control device 10 during normal/abnormal determination when determination target input data x has been input to the determination control device 10. Note that the training processing and the determination processing are examples of a determination control method of technology disclosed herein.

First the training processing will be described in detail, with reference to FIG. 6.

At step S12, the encryption section 22 extracts the low-dimensional feature value z from the input data x using the encryption function f_{θ}(x) including the parameter θ, and outputs the low-dimensional feature value z to the adding section 26.

Next at step S14, the estimation section 12 estimates the probability distribution P_{ψ}(z) of the low-dimensional feature value z using the GMM including the parameter ψ. The estimation section 12 also computes the entropy R of the probability distribution P_{ψ}(z)=−log (P_{ψ}(z))

Next at step S16, the noise generation section 24 generates noise ε that is a random number based on a distribution having the same dimensionality as the low-dimensional feature value z, having no inter-correlation between dimensions, and having a mean of 0, and outputs the noise ε to the adding section 26. The adding section 26 then generates a low-dimensional feature value z\hat{ } resulting from adding the noise ε input from the noise generation section 24 to the low-dimensional feature value z input from the encryption section 22, and outputs the low-dimensional feature value z\hat{ } to the decryption section 28. Furthermore, the decryption section 28 decrypts the low-dimensional feature value z\hat{ } using the decryption function g_{φ}(z\hat{ }) including the parameters φ, and generates output data x\hat{ }.

Next at step S18, the adjustment section 14 computes an error between the input data x and the output data x\hat{ } generated at step S16, such as, for example, D=(x−x\hat{ })².

Next at step S20, the adjustment section 14 computes a training cost L₁ expressed by, for example, a weighted sum of the error D computed at step S18, and the entropy R computed by the estimation section 12 at step S14, as expressed in Equation (2).

Next at step S22, the adjustment section 14 updates the parameter θ of the encryption section 22, the parameter φ of the decryption section 28, and the parameter ψ of the estimation section 12 so as to decrease the training cost L₁.

Next at step S24, the adjustment section 14 determines whether or not training has converged. For example, training can be determined as having converged in cases in which the number of times of repeatedly updating the parameters has reached a specific number of times, cases in which the value of the training cost L₁ has stopped changing, and the like. Processing returns to step S12 in cases in which training has not converged, and the processing of steps S12 to S22 is repeated for the next input data x. The training processing is ended in cases in which the training has converged.

Next, a detailed description follows regarding the determination processing, with reference to FIG. 7. The determination processing is started in a state in which the parameters θ, φ, ψ after being adjusted by the training processing have been set respectively in the encryption section 22, the decryption section 28, and the estimation section 12.

At step S32, the encryption section 22 extracts the low-dimensional feature value z from the input data x by using the encryption function f_{θ}(x) including the parameter θ.

Next at step S34, the estimation section 12 estimates the probability distribution P_{ψ}(z) of the low-dimensional feature value z using the GMM including the parameter ψ. Moreover, the estimation section 12 computes the probability distribution P_{ψ}(z) entropy R=−log (P_{ψ}(z)). Furthermore, the estimation section 12 computes the membership coefficient γ of the GMM.

Next at step S36, the determination section 16 identifies, as cluster information indicating which cluster the low-dimensional feature value z belongs to, a cluster equivalent to the normal distribution corresponding to the maximum coefficient from among the coefficients γₖ contained in the K dimensional vector that is the computed membership coefficient γ.

Next at step S38, from among the determination standards pre-determined for each respective cluster, the determination section 16 sets the determination standard corresponding to the cluster information identified at step S36, namely corresponding to the cluster the low-dimensional feature value z belongs to. The determination section 16 then determines for the determination target input data x whether the input data x is normal or abnormal by comparing the entropy R computed by the estimation section 12 at step S34 against the determination standard that was set.

Next at step S40, the determination section 16 outputs the result of normal/abnormal determination, and then ends the determination processing.

As described above, the determination control device according to the first exemplary embodiment encrypts the input data, estimates the low-dimensional feature value obtained as a probability distribution, and decrypts the feature value resulting from adding noise to the low-dimensional feature value to generate the output data. Moreover, the determination control device adjusts the respective parameters for encryption, probability distribution estimation, and decryption based on the training cost including the error between the input data and output data and the probability distribution entropy. The determination control device then determines whether or not the determination target input data is normal using the parameters after adjustment, and sets the determination standard corresponding to the cluster that the low-dimensional feature value belongs to. This accordingly enables normal/abnormal determination to be performed by comparison of a local feature in a cluster after clustering on the low-dimensional feature value has been performed using a broad feature exhibited by the low-dimensional feature value. This accordingly enables distinguishing between normal and abnormal to be suppressed from becoming difficult even in cases in which an input data feature exhibits various probability distributions, and a difference between normal and abnormal is a local feature, thereby enabling control such that determination between normal or abnormal can be performed with good accuracy.

### Second Exemplary Embodiment

Next, description follows regarding a second exemplary embodiment. Note that detailed explanation will be omitted regarding parts of the determination control device according to the second exemplary embodiment common to those of the determination control device 10 according to the first exemplary embodiment.

A determination control device 210 according to the second exemplary embodiment includes, from a functional perspective, an autoencoder 220, an estimation section 212, an adjustment section 214, and a determination section 216, as illustrated in FIG. 2. The estimation section 212 and the adjustment section 214 function during training of the autoencoder 220, and the estimation section 212 and the determination section 216 function during normal/abnormal determination using the autoencoder 220. Explanation follows regarding a detailed configuration of the autoencoder 220 and regarding the function of each functional section during training and during determination, respectively.

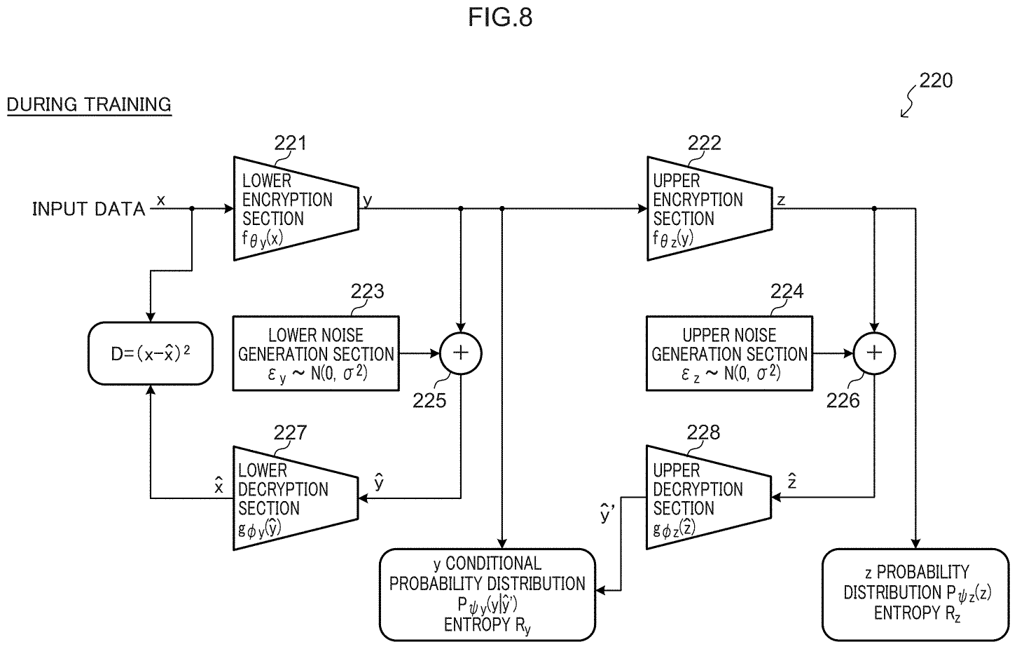

First, explanation follows regarding functional sections that function during training, with reference to FIG. 8.

As illustrated in FIG. 8, the autoencoder 220 includes a lower encryption section 221, an upper encryption section 222, a lower noise generation section 223, an upper noise generation section 224, a lower adding section 225, an upper adding section 226, a lower decryption section 227, and an upper decryption section 228.

The lower encryption section 221 extracts an intermediate output y of low-dimensional feature values from input data x using an encryption function f_{θy}(x) including a parameter θy. The lower encryption section 221 outputs the extracted intermediate output y to the lower adding section 225 and the upper encryption section 222. The upper encryption section 222 extracts a low-dimensional feature value z from the intermediate output y using an encryption function f_{θz}(y) including a parameter θz. The upper encryption section 222 outputs the extracted low-dimensional feature value z to the upper adding section 226. A CNN algorithm may be applied as the encryption function f_{θy}(x) and the encryption function f_{θz}(y)

The lower noise generation section 223 generates a noise ε_{y} having the same dimensionality as the intermediate output y, and outputs the generated noise to the lower adding section 225. The upper noise generation section 224 generates a noise ε_{z} having the same dimensionality as the low-dimensional feature value z, and outputs the generated noise to the upper adding section 226. The noise ε_{y} and noise ε_{z} are each a random number based on a distribution having no inter-correlation between dimensions, and having a mean of 0.

The lower adding section 225 adds the noise ε_{y} input from the lower noise generation section 223 to the intermediate output y input from the lower encryption section 221 so as to generate an intermediate output y\hat{ } (“\hat{ }(hat)” above “y” in the drawings), and outputs the intermediate output y\hat{ } to the lower decryption section 227. The upper adding section 226 adds the noise ε_{z} input from the upper noise generation section 224 to the low-dimensional feature value z input from the upper encryption section 222 so as to generate a low-dimensional feature value z\hat{ }, and outputs the low-dimensional feature value z\hat{ } to the upper decryption section 228.

The lower decryption section 227 generates output data x\hat{ } having the same dimensionality as the input data x by decrypting the intermediate output y\hat{ } input from the lower adding section 225 using a decryption function g_{φy}(y\hat{ }) including a parameter φy. The upper decryption section 228 generates an intermediate output y\hat{ }′ having the same dimensionality as the intermediate output y by decrypting the low-dimensional feature value z\hat{ } input from the upper adding section 226 using a decryption function g_{φz}(z\hat{ }) including parameter φz. A transposed-convolution CNN algorithm may be applied as the decryption function g_{φy}(y\hat{ }) and decryption function g_{φz}(z\hat{ }).

Similarly to the estimation section 12 in the first exemplary embodiment, the estimation section 212 acquires the low-dimensional feature value z extracted by the upper encryption section 222, and estimates a probability distribution P_{ψz}(z) of the low-dimensional feature value z using the GMM including the parameter ψz. The estimation section 212 also computes the entropy R_{z} of the probability distribution P_{ψz}(z)=−log (P_{ψz}(z)).

Furthermore, the estimation section 212 also acquires the intermediate output y extracted by the lower encryption section 221 and the intermediate output y\hat{ }′ generated by the upper decryption section 228, and estimates the intermediate output y as a conditional probability distribution under local feature values of the intermediate output y and the intermediate output y\hat{ }′. For example, the estimation section 212 employs a multi-dimensional Gaussian distribution model including parameter wy to estimate a conditional probability distribution P_{ψy}(y|y\hat{ }′).

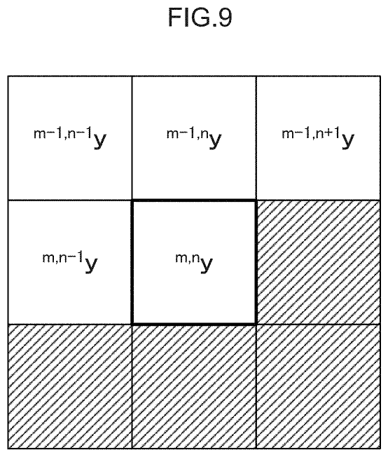

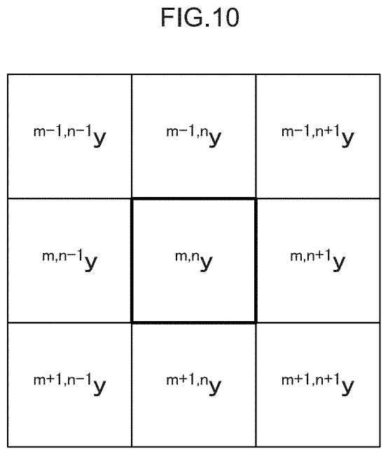

More specifically, the estimation section 212, for example, uses an auto-regressive (AR) model such as a masked CNN or the like to estimate parameters μ and σ of a multi-dimensional Gaussian distribution from information in peripheral regions to the intermediate output y and the intermediate output y\hat{ }′. An AR model is a model that predicts a next frame from directly proceeding frames. For example, when a masked CNN having a kernel size of 1 is utilized for a case in which the input data is image data, as illustrated in FIG. 9, the estimation section 212 extracts ^{m-1, n-1}y, ^{m-1, n}y, ^{m-1, n+1}y, and ^{m, n-1}y as a peripheral region to a pixel of interest ^{m,n}y. Moreover, the estimation section 212 also similarly extracts a peripheral region ^{m-1, n-1}y\hat{ }′, ^{m-1, n}y\hat{ }′, ^{m-1, n+1}y\hat{ }′, and ^{m, n-1}y\hat{ }′ from intermediate output y\hat{ }′. Note that an entire peripheral region to a pixel of interest ^{m, n}y may be utilized as the peripheral region, as illustrated in FIG. 10. The estimation section 212 uses the information about the peripheral region of the pixel of interest ^{m, n}y to estimate ^{m, n}μ_{(y)} and ^{m, n}σ_{(y)} which are parameters of a probability distribution of the pixel of interest ^{m, n}y.

Moreover, the estimation section 212 employs the estimated μ_{(y)} and σ_{(y)} to compute the conditional probability distribution P_{ψy}(y|y\hat{ }′) entropy R_{y}=−log (P_{ψy}(y|y\hat{ }′)) using the following Equation (3). Note that i in Equation (3) is a variable to identify pixels (^{m, n}y in the image data example above) in each dimension of the intermediate output y.

$${R}_{y} = \frac{1}{2} {\sum }_{i} ( \frac{{( {μ}_{i ( y )} - {y}_{i} )}^{2}}{{σ}_{i ( y )}^{2} + {σ}^{2}} - log \frac{{σ}^{2}}{{σ}_{i ( y )}^{2} + {σ}^{2}} ) \qquad ( 3 )$$

The adjustment section 214 computes a training cost L₂ including an error between the input data x and the output data x\hat{ } corresponding to this input data, and including the entropy R_{z} and the entropy R_{y} computed by the estimation section 212. The adjustment section 214 adjusts the respective parameters θz, θy, φz, φy, ψz, ψy in the lower encryption section 221, the upper encryption section 222, the lower decryption section 227, the upper decryption section 228, and the estimation section 212 based on the training cost L₂. For example, the adjustment section 214 repeatedly executes processing to generate the output data x\hat{ } from the input data x while updating the parameters θz, θy, φz, φy, ψz, ψy so as to minimize the training cost L₂ expressed by a weighted sum of the error between x and x\hat{ } and the entropies R_{z} and R_{y} as illustrated in the following Equation (4). The parameters of the autoencoder 220 and the estimation section 212 are trained thereby.

L₂=E_{x˜p(x),ε}_{_{z}}_{˜N(0,σ}_{²}_{),ε}_{_{y}}_{˜N(0,σ}_{²}₎[R_{z}+R_{y}+λ·D] (4)

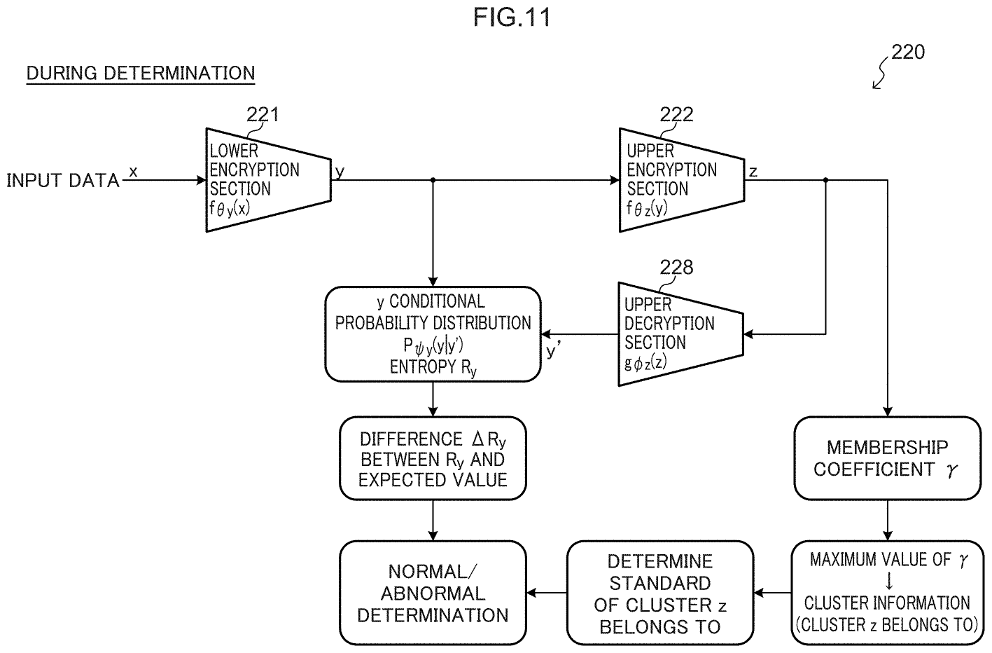

Next, description follows regarding functional sections that function during determination, with reference to FIG. 11.

The lower encryption section 221 extracts the intermediate output y of the low-dimensional feature value from the input data x by encrypting the input data x based on the encryption function f_{θy}(x) set with the parameter θy adjusted by the adjustment section 214, and inputs the intermediate output y to the upper encryption section 222.

The upper encryption section 222 extracts the low-dimensional feature value z from the intermediate output y by encrypting the intermediate output y based on the encryption function f_{θz}(y) set with the parameter θz adjusted by the adjustment section 214, and inputs the low-dimensional feature value z to the upper decryption section 228.

The upper decryption section 228 generates the intermediate output y′ having the same dimensionality as the intermediate output y by decrypting the low-dimensional feature value z input from the upper encryption section 222 using the decryption function g_{φz}(z) including the parameter φz adjusted by the adjustment section 214.

The estimation section 212 acquires the low-dimensional feature value z extracted by the upper encryption section 222, and estimates the probability distribution P_{ψz}(z) of the low-dimensional feature value z using the GMM set with the parameter ψz adjusted by the adjustment section 214. The estimation section 212 computes the membership coefficient γ of the GMM in the process to estimate the probability distribution P_{ψz}(z).

Moreover, the estimation section 212 also acquires the intermediate output y extracted by the lower encryption section 221 and the intermediate output y′ generated by the upper decryption section 228. The estimation section 212 estimates the intermediate output y as the conditional probability distribution P_{ψy}(y|y\hat{ }′) under local feature values of the intermediate output y and the intermediate output y′ using a multi-dimensional Gaussian distribution model including the parameter ψy adjusted by the adjustment section 214. The estimation section 212 estimates the parameters μ_{(y)} and σ_{(y)} of the multi-dimensional Gaussian distribution while estimating the conditional probability distribution P_{ψy}(y|y\hat{ }′).

Moreover, the estimation section 212 uses the following Equation (5) to compute a difference ΔR_{y} between the entropy R_{y} as computed from the estimated μ_{(y)} and σ_{(y)} using the Equation (3), and an expected value of entropy as computed from the estimated σ_{(y)}.

$$Δ {R}_{y} = \frac{1}{2} {\sum }_{i} ( \frac{{( {μ}_{i ( y )} - {y}_{i} )}^{2} - {σ}_{i ( y )}^{2}}{{σ}_{i ( y )}^{2} + {σ}^{2}} ) \qquad ( 5 )$$

Similarly to the determination section 216 of the first exemplary embodiment, the determination section 216 uses the membership coefficient γ computed by the estimation section 212 to identify cluster information indicating which cluster the low-dimensional feature value z belongs to. The determination section 16 sets, from among respective determination standards pre-determined for each cluster, a determination standard corresponding to the identified cluster information, namely to the cluster the low-dimensional feature value z belongs to. Then for the determination target input data x, the determination section 216 determines the input data x to be normal or abnormal by comparing the entropy difference ΔR_{y} computed by the estimation section 212 against the determination standard set corresponding to the cluster the low-dimensional feature value z belongs to.

The determination control device 210 may be implemented by, for example, the computer 40 illustrated in FIG. 5. The storage section 43 of the computer 40 is stored with a determination control program 250 that causes the computer 40 to function as the determination control device 210 so as to execute training processing and determination processing, described later. The determination control program 250 includes an autoencoder process 260, an estimation process 252, an adjustment process 254, and a determination process 256.

The CPU 41 reads the determination control program 250 from the storage section 43, expands the determination control program 250 in the memory 42, and sequentially executes the processes of the determination control program 250. The CPU 41 operates as the autoencoder 220 illustrated in FIG. 2 by executing the autoencoder process 260. The CPU 41 operates as the estimation section 212 illustrated in FIG. 2 by executing the estimation process 252. The CPU 41 operates as the adjustment section 214 illustrated in FIG. 2 by executing the adjustment process 254. The CPU 41 operates as the determination section 216 illustrated in FIG. 2 by executing the determination process 256. The computer 40 that has executed the determination control program 250 accordingly functions as the determination control device 210.

Note that the functions implemented by the determination control program 250 may, for example, be implemented by a semiconductor integrated circuit, and more particularly by an application specific integrated circuit (ASIC).

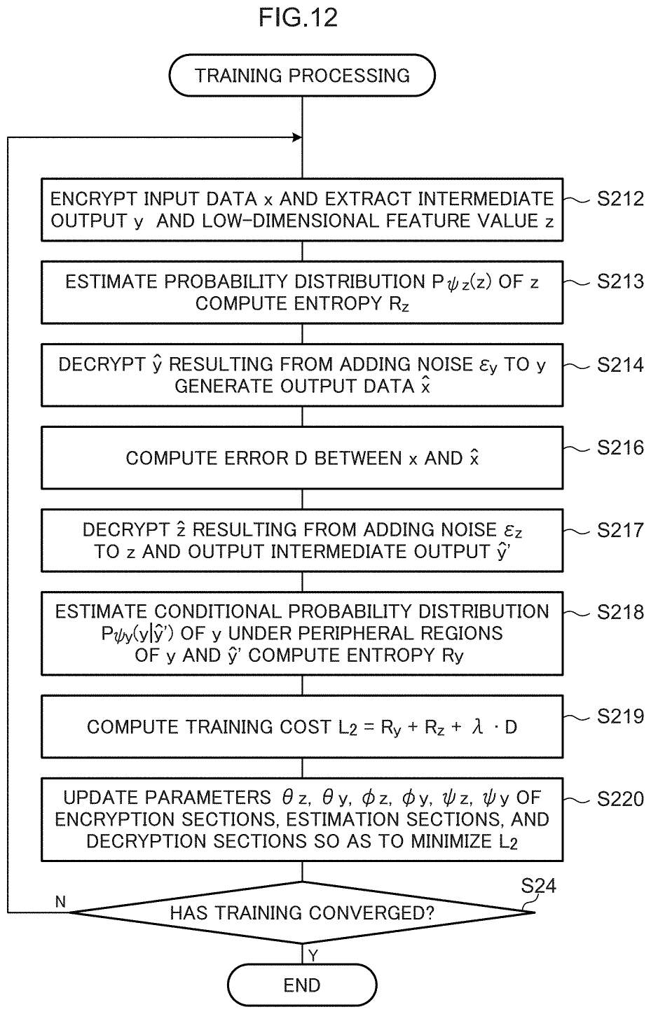

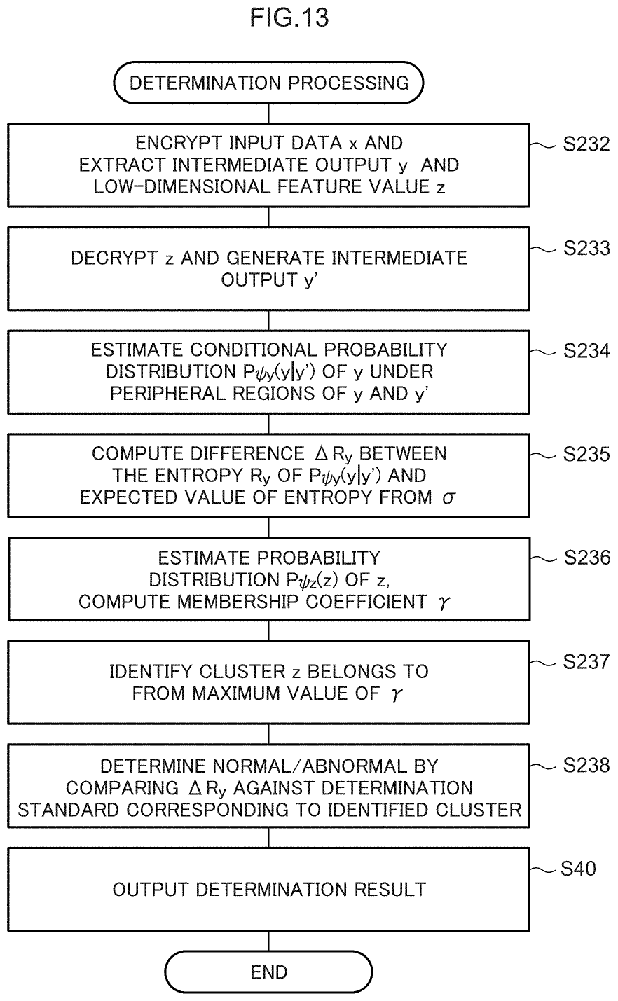

Next, description follows regarding operation of the determination control device 210 according to the second exemplary embodiment. While adjusting the parameters of the autoencoder 220 and the estimation section 212, the training processing illustrated in FIG. 12 is executed in the determination control device 210 when the target input data x is input to the determination control device 210. Moreover, during determination of normal or abnormal, the determination processing illustrated in FIG. 13 is executed in the determination control device 210 when the determination target input data x is input to the determination control device 210.

First the training processing will be described in detail, with reference to FIG. 12.

At step S212, the lower encryption section 221 uses the encryption function f_{θy}(x) including the parameter θy to extract the intermediate output y of the low-dimensional feature value from the input data x, and outputs the intermediate output y to the lower adding section 225 and the upper encryption section 222. The upper encryption section 222 uses the encryption function f_{θz}(y) including the parameter θz to extract the low-dimensional feature value z from intermediate output y, and outputs the low-dimensional feature value z to the upper adding section 226.

Next at step S213, the estimation section 212 estimates the probability distribution P_{ψz}(z) of the low-dimensional feature value z using the GMM including the parameter ψz. The estimation section 212 also computes the probability distribution P_{ψz}(z) entropy R=−log (P_{ψz}(z)).

Next, at step S214, the lower noise generation section 223 generates noise ε_{y} that is a random number based on a distribution having the same dimensionality as the intermediate output y, having no inter-correlation between dimensions, and having a mean of 0, and outputs the noise ε_{y} to the lower adding section 225. The lower adding section 225 then generates an intermediate output y\hat{ } resulting from adding the noise ε_{y} input from the lower noise generation section 223 to the intermediate output y input from the lower encryption section 221, and then outputs the intermediate output y\hat{ } to the lower decryption section 227. Furthermore, the lower decryption section 227 also decrypts the intermediate output y\hat{ } using the decryption function g_{φy}(y\hat{ }) including the parameter φy, and generates output data x\hat{ }.

Next at step S216, the adjustment section 214 computes an error between the input data x and the output data x\hat{ } generated at step S214, such as D=(x−x\hat{ })² for example.

Next at step S217, the upper noise generation section 224 generates noise ε_{z} that is a random number based on a distribution having the same dimensionality as the low-dimensional feature value z, having no inter-correlation between dimensions, and having a mean of 0, and outputs the noise ε_{z} to the upper adding section 226. The upper adding section 226 generates a low-dimensional feature value z\hat{ } resulting from adding the noise ε_{z} input from the upper noise generation section 224 to the low-dimensional feature value z input from the upper encryption section 222, and outputs the low-dimensional feature value z\hat{ } to the upper decryption section 228. Furthermore, the upper decryption section 228 decrypts the low-dimensional feature value z\hat{ } using a decryption function g_{φz}(z\hat{ }) including the parameter φz, and generates an intermediate output y\hat{ }′.

Next, at step S218, the estimation section 212 uses an AR model, for example, to extract a peripheral region to each of the intermediate output y extracted by the lower encryption section 221 and the intermediate output y\hat{ }′ generated by the upper decryption section 228. The estimation section 212 then estimates the intermediate output y as a conditional probability distribution P_{ψy}(y|y\hat{ }′) by estimating parameters μ_{(y)} and σ_{(y)} of a multi-dimensional Gaussian distribution. The estimation section 212 employs the estimated μ_{(y)} and σ_{(y)} to compute the conditional probability distribution P_{ψy}(y|y\hat{ }′) entropy R_{y}=−log (P_{ψy}(y|y\hat{ }′)) using Equation (3).

Next at step S219, the adjustment section 214 computes a training cost L₂, for example as expressed by Equation (4), expressed by a weighted sum of the error D computed at step S216 and the entropy R_{z} and the entropy R_{y} computed at step S213 and step S218.

Next, at step S220, the adjustment section 214 updates the respective parameters θz, θy, φz, φy, ψz, ψy of the lower encryption section 221, the upper encryption section 222, the lower decryption section 227, the upper decryption section 228, and the estimation section 212 so as to decrease the training cost L₂.

Next, at step S24, the adjustment section 214 determines whether or not training has converged. In cases in which training has not converged, processing returns to step S212, and the processing of step S212 to step S220 is repeated for the next input data x. The training processing is ended in cases in which training has converged.

Next detailed description will be given regarding determination processing, with reference to FIG. 13. The determination processing is started in a state in which the parameters θz, θy, φz, φy, ψz, ψy that have been adjusted by the training processing are respectively set in the lower encryption section 221, the upper encryption section 222, the upper decryption section 228, and the estimation section 212.

At step S232, the lower encryption section 221 extracts an intermediate output y from the input data x by using the encryption function f_{θy}(x), and outputs the intermediate output y to the upper encryption section 222. The upper encryption section 222 extracts a low-dimensional feature value z from the intermediate output y using the encryption function f_{θz}(y).

Next at step S233, the upper decryption section 228 decrypts the low-dimensional feature value z using the decryption function g_{φz}(z) and generates an intermediate output y′.

Next at step S234, the estimation section 212 uses an AR model, for example, to extract a peripheral region to each of the intermediate output y extracted by the lower encryption section 221 and the intermediate output y\hat{ }′ generated by the upper decryption section 228. The estimation section 212 then estimates the intermediate output y as a conditional probability distribution P_{ψy}(y|y\hat{ }′) by estimating parameters μ_{(y)} and σ_{(y)} of a multi-dimensional Gaussian distribution.

Next at step S235, the estimation section 212 uses Equation (5) to compute a difference ΔR_{y} between the entropy R_{y} as computed at step S234 from the estimated μ_{(y)} and σ_{(y)} using the Equation (3), and an expected value of entropy as computed from the estimated σ_{(y)}.

Next, at step S236, the estimation section 212 uses a GMM to estimate a probability distribution P_{ψz}(z) for the low-dimensional feature value z, and computes a membership coefficient γ of the GMM.

Next based on the membership coefficient y computed at step S236, at step S237 the determination section 216 identifies cluster information indicating which cluster the low-dimensional feature value z belongs to.

Next at step S238, from among respective determination standards pre-determined for each respective cluster, the determination section 216 sets a determination standard corresponding to the cluster information identified at step S237, namely to the cluster the low-dimensional feature value z belongs to. Then for the determination target input data x, the determination section 216 determines the input data x to be normal or abnormal by comparing the entropy difference ΔR_{y} computed by the estimation section 212 at step S235 against the determination standard that was set.

Next, at step S40, the determination section 216 outputs a determination result of normal or abnormal, and ends the determination processing.

As described above, the determination control device according to the second exemplary embodiment extracts an intermediate output of the low-dimensional feature value by lower layer encryption, and extracts the low-dimensional feature value by upper layer encryption. Moreover, for respective outputs of the decrypted intermediate output and low-dimensional feature value, the determination control device estimates a conditional probability distribution of data of interest under information of the peripheral region to the data of interest in the intermediate output. Moreover, similarly to in the first exemplary embodiment, the determination control device sets a determination standard corresponding to the cluster that the low-dimensional feature value belongs to. The determination control device then determines whether or not the determination target input data is normal using the entropy of the estimated conditional probability distribution and the determination standard. The accordingly enables determination of normal or abnormal to be performed by evaluation of a local feature expressed by the intermediate output under a broad feature expressed by the low-dimensional feature value. This accordingly enables distinguishing between normal and abnormal to be suppressed from becoming difficult even in cases in which the input data feature exhibits various probability distributions, and a difference between normal and abnormal is a local feature, thereby enabling control such that determination between normal or abnormal can be performed with good accuracy.

Note that in the second exemplary embodiment, a uniform distribution U (−½, ½) may be employed for the noise ε_{y} added to the intermediate output y to generate the intermediate output y\hat{ }. In such cases, the conditional probability distribution P_{ψy}(y|y\hat{ }′) estimated during training is that of following Equation (6). Moreover, the entropy difference ΔR_{y} computed during estimation is that of following Equation (7). Note that C in Equation (7) is a constant determined experimentally according to the designed model.

$${P}_{ψ y} ( y \vert {\hat{y}}^{′} ) = {\prod }_{i} ( N ( {μ}_{i ( y )} , {σ}_{i ( y )}^{2} ) * U ( - \frac{1}{2} , \frac{1}{2} ) ) ( {y}_{i} ) \qquad ( 6 )$$

$$Δ {R}_{y} = - log ( {P}_{ψ y} ( y \vert {y}^{′} ) ) - \frac{1}{2} {\sum }_{i} max ( log ( 2 π e {σ}_{i ( y )}^{2} ) - log ( \frac{π e}{6} ) + C , 0 ) \qquad ( 7 )$$

Moreover, although each of the exemplary embodiments has been described mainly based on examples of cases in which the input data is image data, the input data may be waveform data, such as that of an electrocardiogram or an electroencephalogram. In such cases, for example, a CNN or the like transformed onto a single dimension may be employed as the algorithm used for encryption and the like.

Moreover, although each of the exemplary embodiments has been described mainly with respect to determination control devices including each of the functional sections employed during training and during determination in a single computer, there is no limitation thereto. A training device including an autoencoder, estimation section, and an adjustment section where parameters prior to adjustment are employed, and a determination device including an autoencoder, estimation section, and a determination section where already adjusted parameters are employed, may each be configured by a separate computer.

Moreover, although each of the exemplary embodiments has been described for an embodiment in which the determination control program is pre-stored (installed) in the storage section, there is no limitation thereto. The program according to the technology disclosed herein may be provided in a format stored on a storage medium such as a CD-ROM, DVD-ROM, USB memory, or the like.

In related technology there is an issue in that sometimes determination as normal or abnormal is not able to be made with good accuracy in cases in which the input data feature exhibits various probability distributions, and a feature of a probability distribution indicating abnormal data is buried in differences between the various probability distributions.

The technology disclosed herein enables determination of normal or abnormal to be performed with good accuracy even in cases in which input data feature exhibits various probability distributions.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory recording medium storing a determination control program that causes a computer to execute a process comprising:
estimating, as a probability distribution, a low-dimensional feature value obtained by encrypting input data, the low-dimensional feature value having a lower dimensionality than the input data;
generating output data by decrypting a feature value resulting from adding noise to the low-dimensional feature value; and
adjusting respective parameters of the encrypting, the estimating, and the decrypting, based on a cost including an error between the input data and the output data and including an entropy of the probability distribution
wherein, in a determination as to whether or not target input data is normal, a determination standard for the determination is controlled based on information obtained from another probability distribution estimated by encrypting the target input data with the parameters after the adjusting.

2. The non-transitory recording medium of claim 1, wherein:
a probability distribution resulting from mixing a plurality of distributions is estimated as the probability distribution; and
from among a plurality of clusters equivalent to the plurality of distributions, which cluster the low-dimensional feature value belongs to is identified based on the information obtained from the other probability distribution, and a determination standard corresponding to the cluster that is identified is set from among a determination standard for each cluster.

3. The non-transitory recording medium of claim 1, wherein the cost is a weighted sum of the error and the entropy, and the parameters are adjusted so as to minimize the cost.

4. The non-transitory recording medium of claim 1, wherein the noise is a random number based on a distribution having no inter-dimensional correlation, and having a mean of 0.

5. The non-transitory recording medium of claim 1, wherein the determination is performed by comparing an entropy of the other probability distribution for the target input data against the determination standard.

6. The non-transitory recording medium of claim 1, wherein the determination is performed by comparing the determination standard against a difference between an expected value of entropy and an entropy of a conditional probability for an intermediate output of the low-dimensional feature value under data of a peripheral region of data of interest in the intermediate output and the low-dimensional feature value.

7. A determination control device comprising:
a memory; and
a processor coupled to the memory, the processor being configured to execute processing including
estimating, as a probability distribution, a low-dimensional feature value obtained by encrypting input data, the low-dimensional feature value having a lower dimensionality than the input data,
generating output data by decrypting a feature value resulting from adding noise to the low-dimensional feature value, and
adjusting respective parameters of the encrypting, the estimating, and the decrypting based on a cost including an error between the input data and the output data and including an entropy of the probability distribution
wherein, in a determination as to whether or not target input data is normal, a determination standard for the determination is controlled based on information obtained from another probability distribution estimated by encrypting the target input data with the parameters after adjusting.

8. The determination control device of claim 7, wherein:
a probability distribution resulting from mixing a plurality of distributions is estimated as the probability distribution; and
from among a plurality of clusters equivalent to the plurality of distributions, which cluster the low-dimensional feature value belongs to is identified based on the information obtained from the other probability distribution, and a determination standard corresponding to the cluster that is identified is set from among a determination standard for each cluster.

9. The determination control device of claim 7, wherein the cost is a weighted sum of the error and the entropy, and the parameters are adjusted so as to minimize the cost.

10. The determination control device of claim 7 wherein the noise is a random number based on a distribution having no inter-dimensional correlation, and having a mean of 0.

11. The determination control device of claim 7, wherein the determination is performed by comparing an entropy of the other probability distribution for the target input data against the determination standard.

12. The determination control device of claim 7, wherein the determination is performed by comparing the determination standard against a difference between an expected value of entropy and an entropy of a conditional probability for an intermediate output of the low-dimensional feature value under data of a peripheral region of data of interest in the intermediate output and the low-dimensional feature value.

13. A determination control method comprising:
estimating, as a probability distribution, a low-dimensional feature value obtained by encrypting input data, the low-dimensional feature value having a lower dimensionality than the input data;
generating output data by decrypting a feature value resulting from adding noise to the low-dimensional feature value; and
adjusting respective parameters of the encryption, the estimation, and the decryption based on a cost including an error between the input data and the output data, and an entropy of the probability distribution
wherein, in a determination by a processor as to whether or not target input data is normal, a determination standard for the determination is controlled based on information obtained from another probability distribution estimated by encrypting the target input data with the parameters after adjusting.

14. The determination control method of claim 13, wherein:
a probability distribution resulting from mixing a plurality of distributions is estimated as the probability distribution; and
from among a plurality of clusters equivalent to the plurality of distributions, which cluster the low-dimensional feature value belongs to is identified based on the information obtained from the other probability distribution, and a determination standard corresponding to the cluster that is identified is set from among a determination standard for each cluster.

15. The determination control method of claim 13, wherein the cost is a weighted sum of the error and the entropy, and the parameters are adjusted so as to minimize the cost.

16. The determination control method of claim 13, wherein the noise is a random number based on a distribution having no inter-dimensional correlation, and having a mean of 0.

17. The determination control method of claim 13, wherein the determination is performed by comparing an entropy of the other probability distribution for the target input data against the determination standard.

18. The determination control method of claim 13, wherein the determination is performed by comparing the determination standard against a difference between an expected value of entropy and an entropy of a conditional probability for an intermediate output of the low-dimensional feature value under data of a peripheral region of data of interest in the intermediate output and the low-dimensional feature value.
